(19) United States
(12) Patent Application Publication
(10) Pub. No.: US 2006/0043785 A1
(43) Pub. Date: Mar. 2, 2006

(54) Wheel with disc flange groove

(76) Inventor: Joao Batista Tulimosky, Cordeiropolis (BR)

Correspondence Address: CARLSON, GASKEY & OLDS, P.C., 400 WEST MAPLE ROAD, SUITE 350, BIRMINGHAM, MI, 48009, US

(21) Appl. No.: 10/932,752

(22) Filed: Sep. 2, 2004

(51) Int. Cl. B60B 3/10

(52) U.S. Cl. 301/63.101

(57) ABSTRACT

A vehicle wheel includes a wheel disc with a disc flange portion extending toward an outer peripheral edge of the vehicle wheel. A weld area is located on the disc flange portion at the outer peripheral edge. The wheel disc is press fit into a rim and then is welded to the rim at the weld area. A groove is formed within the disc flange portion at a location remote from the weld area. This provides flexibility for the disc flange portion to reduce tension exerted on the weld area between the wheel disc and rim.

### TECHNICAL FIELD

The subject invention relates to a vehicle wheel disc having a disc flange portion with a groove located to reduce tension at a weld attachment interface to a rim.

### BACKGROUND OF THE INVENTION

A vehicle wheel disc includes a disc flange that is first press fit into a rim and then welded to the rim at a weld interface to form a vehicle wheel. The disc flange includes an outer surface that directly abuts against an inner surface of the rim. The outer and inner surfaces are generally linear and abutment occurs along a substantial portion of the length of the disc flange.

In order to provide high robustness, the disc flange traditionally has at least one flange portion with an increased thickness. A typical flange thickness at this flange portion is at least four (4) millimeters but can vary depending upon vehicle load and application. One problem with this increased thickness is that there is no allowance for flexing movement of the disc flange. The direct abutment between the disc flange and the rim at the outer and inner surfaces, in combination with the increased thickness, further prohibits flexing movement.

The inability of the disc flange to flex results in an accumulation of tension at the weld interface between the vehicle wheel disc and the rim. The accumulation of tension increases weld stress and can generate premature cracking at the weld interface. This adversely affects the fatigue life of the vehicle wheel.

Thus, there is a need for a vehicle wheel disc having a disc flange portion that can flex as needed to reduce stress at the weld interface between the vehicle wheel disc and the rim.

### SUMMARY OF THE INVENTION

A vehicle wheel includes a wheel disc with a disc flange portion that extends to a distal edge. A weld area is located on the disc flange portion at the distal edge. A groove is formed within the disc flange portion at a location that is spaced apart from, i.e. remote from, the weld area.

In one example, the groove includes a curved surface with an apex that extends into the disc flange portion. The disc flange portion has a variable thickness with a first flange portion near the distal edge having a first predetermined thickness and a second flange portion at the apex having a second predetermined thickness. The second predetermined thickness is preferably greater than the first predetermined thickness. Both the first and second predetermined thickness are preferably less than four (4) millimeters, but can vary depending on vehicle load and application.

A rim is attached to the wheel disc at the weld area, forming a weld interface. The groove is formed within the disc flange portion to allow flexing movement of the disc flange portion relative to the rim. The flexing movement reduces tension exerted on the weld interface, which improves the overall performance and fatigue life of the vehicle wheel.

These and other features of the present invention can be best understood from the following specification and drawings, the following of which is a brief description.

### BRIEF DESCRIPTION OF THE DRAWINGS

FIG. 1 is a lateral view of a vehicle wheel disc and rim assembly incorporating the subject invention.

FIG. 2 is a magnified view of an attachment interface as indicated in FIG. 1.

### DETAILED DESCRIPTION OF THE PREFERRED EMBODIMENT

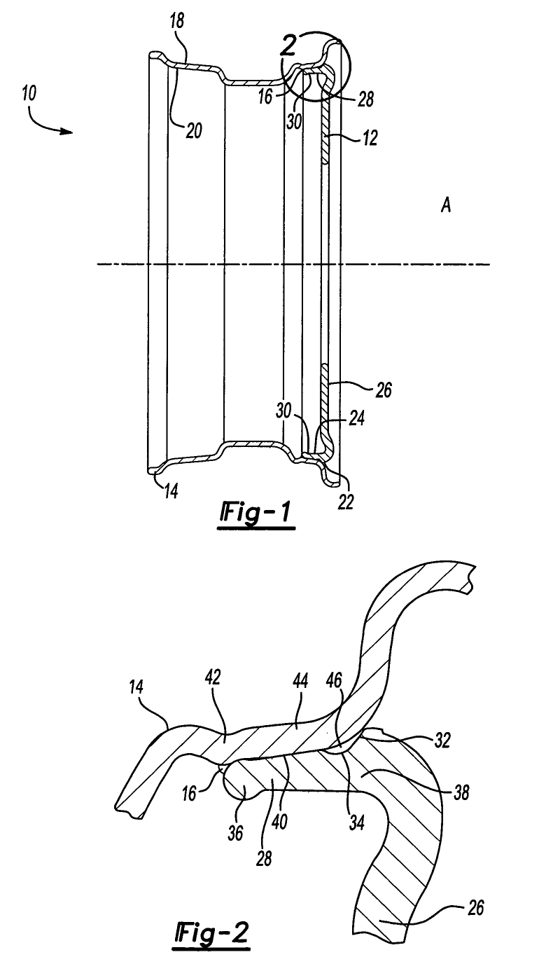

A vehicle rim and wheel assembly 10 is shown in FIG. 1. The vehicle rim and wheel assembly 10 includes a wheel disc 12 and a rim 14. The wheel disc 12 is press fit into the rim 14 and then the wheel disc 12 is attached to the rim 14 at a weld attachment interface, shown generally at 16. The rim 14 and wheel disc 12 rotate together about an axis of rotation A. The wheel disc 12 is mounted to an axle assembly (not shown) in a manner that is well-known in the art.

The rim 14 includes an upper surface 18 that faces a tire (not shown) and a lower surface 20. The wheel disc 12 includes an outer surface 22 that abuts against the lower surface 20 of the rim 14 and an inner surface 24. The wheel disc 12 includes a vertically extending disc portion 26 and a disc flange portion 28 that extends outwardly to a distal peripheral edge 30. The weld attachment interface 16 is located at the distal peripheral edge 30.

As shown in FIG. 2, the disc flange portion 28 includes at least one groove 32 that extends about an outer circumference of the disc flange portion 28. The groove 32 can extend continuously or discontinuously about the outer circumference. The groove 32 includes a curved surface with an apex 34 that extends into the disc flange portion 28.

The disc flange portion 28 includes a first portion 36 at the weld attachment interface 16 and a second portion 38 that transitions into the vertically extending disc portion 26. The groove 32 is spaced apart, i.e. remotely located, from the weld attachment interface 16 at the second portion 38. A generally linear surface 40 extends from the groove 32 to the first portion 36.

The rim 14 is fixed to the disc flange portion 28 at a first rim portion 42 and is spaced apart from the disc flange portion 28 at a second rim portion 44. The weld attachment interface 16 is located at the first rim portion 42.

The disc flange portion 28 includes a variable thickness. The disc flange portion 28 has as first flange thickness adjacent to the first portion 36 and a second flange thickness at the apex 34. The second flange thickness is preferably greater than the first flange thickness. Also, both the first and second flange thickness are preferably less than four (4) millimeters. In one example, the first flange thickness is two and one-half (2.5) millimeters and the second flange thickness is three (3) millimeters. This is significantly less than the traditional flange thickness, which is at least four (4) millimeters. While this configuration is preferred, it should be understood that the flange thickness could be varied, i.e. increased or decreased, depending on vehicle load and application.

As discussed above, the rim 14 is attached to the wheel disc 12 at the weld attachment interface 16. After attachment, a recess 46 is formed at the second rim portion 44 between the lower surface 20 of the rim and the upper surface 22 of the wheel disc 12 at the groove 32. The reduced thickness of the disc flange portion 28 in combination with the groove 32 allows the second portion 38 of the disc flange portion 28 to flex or move relative to the rim 14.

The flexing movement removes tension from the weld attachment interface 16 and transfers tension to other areas in the wheel disc 12. Consequently, the fatigue life and component performance significantly increases compared to prior designs. Further, the number and size of weld cracks are significantly reduced, which leads to the improved fatigue performance.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle wheel comprising:
a disc flange including a weld area for attachment to a rim; and
at least one groove formed within said disc flange and spaced apart from said weld area.

2. The vehicle wheel according to claim 1 including a disc portion wherein said disc flange includes a first end portion that transitions into said disc portion and a second end portion extending transversely relative to said disc portion, said weld area being located at said second end portion.

3. The vehicle wheel according to claim 2 wherein said second end portion includes an outer peripheral edge of the vehicle wheel.

4. The vehicle wheel according to claim 3 including a generally linear surface portion extending from said at least one groove to said outer peripheral edge.

5. The vehicle wheel according to claim 4 wherein said disc flange has a variable thickness.

6. The vehicle wheel according to claim 5 including a first disc flange thickness defined adjacent said weld area and a second disc flange thickness defined at an apex of said at least one groove wherein said second disc flange thickness is greater than said first disc flange thickness.

7. The vehicle wheel according to claim 2 wherein the rim is attached to the disc flange at the weld area.

8. The vehicle wheel according to claim 7 including a recess formed between a surface defining said at least one groove and the rim.

9. The vehicle wheel according to claim 7 wherein the rim includes a first portion fixed to said disc flange at said weld area and a second portion spaced apart from said disc flange at said at least one groove to allow relative movement between the second portion of the rim and the first end portion of the disc flange.

10. The vehicle wheel according to claim 1 wherein said at least one groove includes a curved surface having an apex extending into said disc flange.

11. A method of forming a vehicle wheel comprising;
forming a groove in a disc flange at an area remote from a disc flange weld area.

12. The method according to claim 11 including forming a linear surface on the disc flange that extends from an edge of said groove toward the disc flange weld area.

13. The method according to claim 12 including forming the groove as a curved surface having an apex extending into the disc flange.

14. The method according to claim 11 wherein the disc flange weld area is attached to a rim.

15. The method according to claim 11 including providing the disc flange with a flange thickness that is less than four millimeters.

16. A vehicle wheel comprising:
a rim defining an inner wheel cavity;
a wheel disc having a center disc and a disc flange formed about a circumference of said center disc, said disc flange extending generally transverse to said center disc and into said inner wheel cavity;
a weld attachment area formed between said disc flange and said rim; and
a groove formed within said disc flange and spaced apart from said weld attachment area to allow relative movement between said rim and said wheel disc at said groove.

17. The vehicle wheel according to claim 16 wherein said disc flange includes a first end portion that transitions into said center disc and a second end portion extending transverse to said center disc, said weld attachment area being located at said second end portion.

18. The vehicle wheel according to claim 17 wherein said groove is formed in an outer surface of disc flange to provide a recess between said outer surface and an inner surface of said rim.

19. The vehicle wheel according to claim 16 wherein said wheel disc is press fit into said rim prior to forming said weld attachment area.
